(19) United States
(12) Patent Application Publication
(10) Pub. No.: US 2021/0332867 A1
(43) Pub. Date: Oct. 28, 2021

(54) AIR SUSPENSION ASSEMBLY AND BELLOWS FOR AN AIR SUSPENSION ASSEMBLY

(71) Applicant: BeijingWest Industries Co., Ltd, Beijing (CN)

(72) Inventors: Iain ROSE, Luton Beds (GB); Baptiste CHEVALLEREAU, Paris (FR); Jocelyn MARCHAND, Levallois Perret (FR)

(21) Appl. No.: 17/237,056

(22) Filed: Apr. 22, 2021

Related U.S. Application Data
(60) Provisional application No. 63/016,237, filed on Apr. 27, 2020.

(30) Foreign Application Priority Data
Feb. 26, 2021 (CN) 202110217133.4

(51) Int. Cl. F16F 9/084; F16F 9/04; F16F 9/58

(52) U.S. Cl. CPC F16F 9/084; F16F 9/0472; B60G 15/14; F16F 9/585; F16F 2222/126; F16F 9/0409

(57) ABSTRACT

An air suspension assembly comprises a top and a bottom disposed on a center axis and spaced apart from one another. A bellows of an elastomeric material extends between a first end secured to the top and a second end secured to the bottom defining a chamber. The chamber extends between the top, the bottom, and the bellows for containing pressurized air, whereby a pressure of the pressurized air is controlled based on a force applied. The bellows has an interior surface and an exterior surface and including a plurality of convolutes extending between the first end and the second end. Each convolute of the plurality of convolutes includes a pair of outer lobes and an inner lobe with each outer lobe of the pair of outer lobes having an outer lobe thickness extending between the interior surface and the exterior surface of the bellows.

### CROSS-REFERENCE TO RELATED APPLICATIONS

This application claims the benefit of U.S. Provisional Application Patent Ser. No. 63/016,237, filed on Apr. 27, 2020, and Chinese Patent Application No. 202110217133.4 filed on Feb. 26, 2021, the entire disclosures of which are incorporated herein by reference in their entirety.

### BACKGROUND OF THE INVENTION

### 1. Field of the Invention

The present invention generally relates to an air suspension assembly.

### 2. Description of the Prior Art

Air suspension assemblies are often used in the axle/suspension systems of a vehicle. They can also be used in other applications, such as, for example, cushioning the cab of a vehicle. Typically, the air suspension assemblies utilize boots to cushion the ride, dampen vibrations, and stabilize the vehicle. The air sleeve, operating as a rolling lobe, is ordinarily made of rubber and cords so that the air sleeve has a high enough strength to maintain air pressure inside the air sleeve. The use of an air sleeve requires a costly rubber-forming process and typically requires great air pressure to support it. Reinforcing cords are required and often an additional restraining cylinder is required to withstand this pressure.

One such an air suspension assembly is disclosed in U.S. Pat. No. 10,618,366. The air suspension assembly comprises a top and a bottom disposed on a center axis and spaced apart from one another. A bellows of an elastomeric material extends between a first end secured to the top and a second end secured to the bottom defining a chamber. The chamber extends between the top, the bottom, and the bellows for containing pressurized air, whereby a pressure of the pressurized air is controlled based on a force applied. The bellows has an interior surface and an exterior surface and including a plurality of convolutes extending between the first end and the second end.

### SUMMARY OF THE INVENTION

The present invention provides for an air suspension assembly that is simple and cost-effective by replacing the rubber bellows previously used in other air suspension assemblies with a robust thermoplastic elastomer bellows. In addition, the invention also provides a simple and cost-effective manufacturing process of forming the bellows. Furthermore, the invention provides cost reduction by requiring a lower-power compressor to support the bellows.

It is one aspect of the present invention to provide an air suspension assembly. The air suspension assembly comprises a top and a bottom disposed on a center axis and spaced apart from one another. A bellows of an elastomeric material extends between a first end secured to the top and a second end secured to the bottom defining a chamber. The chamber extends between the top, the bottom, and the bellows for containing pressurized air, whereby a pressure of the pressurized air is controlled based on a force applied. The bellows has an interior surface and an exterior surface and including a plurality of convolutes extending between the first end and the second end. Each convolute of the plurality of convolutes includes a pair of outer lobes and an inner lobe with each outer lobe of the pair of outer lobes having an outer lobe thickness extending between the interior surface and the exterior surface of the bellows.

It is another aspect of the present invention to provide an air suspension assembly. The air suspension assembly comprises a top and a bottom disposed on a center axis and spaced apart from one another. A piston is disposed on the center axis spaced from the top. A bellows extends about the center axis between a first end secured to the top and a second end secured to the bottom connecting the top and the bottom defining a chamber extending between the top, the bottom, and the bellows. The bellows having an interior surface and an exterior surface. The bellows includes a plurality of convolutes extending between the first end and the second end. The chamber contains pressurized air in fluid communication with the piston. A pressure of the pressurized air is controlled based on a force applied to the air suspension assembly. A damper is connected to the piston and moveable between a compressed position and an undeformed position. A jounce bumper is connected to the top for absorbing energy of the damper when the air suspension assembly is compressed. The damper compresses the jounce bumper in the compressed position and the damper is spaced from the jounce bumper in the undeformed position.

It is another aspect of the present invention to provide a bellows of an air suspension assembly. The bellows comprises an interior surface and an exterior surface. A first end is secured to a top of the air suspension assembly. A second end is secured to a bottom of the air suspension assembly connecting the top and the bottom defining a chamber extending about a center axis between the top, the bottom, and the bellows. A plurality of convolutes extends between the first end and the second end. Each of the plurality of convolutes extends between a pair of outer lobes spaced from one another along the center axis. The outer lobe has an outer lobe thickness extending between the interior surface and the exterior surface of the bellows. An inner lobe disposed radially inwardly from the outer lobes and between the outer lobes. The inner lobe has an inner lobe thickness extending between the interior surface and the exterior surface of the bellows. The outer lobe thickness and the inner lobe thickness are approximately equivalent. A bridge portion extends between the inner lobe and each one of the pair of outer lobes. The bridge portion has a bridge portion thickness extending between the interior surface and the exterior surface of the bellows. Each of the outer lobe thickness and the inner lobe thickness is greater than the bridge portion thickness.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional view of an air suspension assembly in a default operating position constructed according to an embodiment of the present invention;

FIG. 2 is a cross-sectional view of the air suspension assembly in a compressed position constructed according to an embodiment of the present invention;

FIG. 3 is a cross-sectional view of the air suspension assembly in a undeformed position;

FIG. 4 is a fragmentary cross-sectional view of a convolute of a bellow; and

FIG. 5 is a load deflection curve of the air suspension assembly.

### DESCRIPTION OF THE ENABLING EMBODIMENT

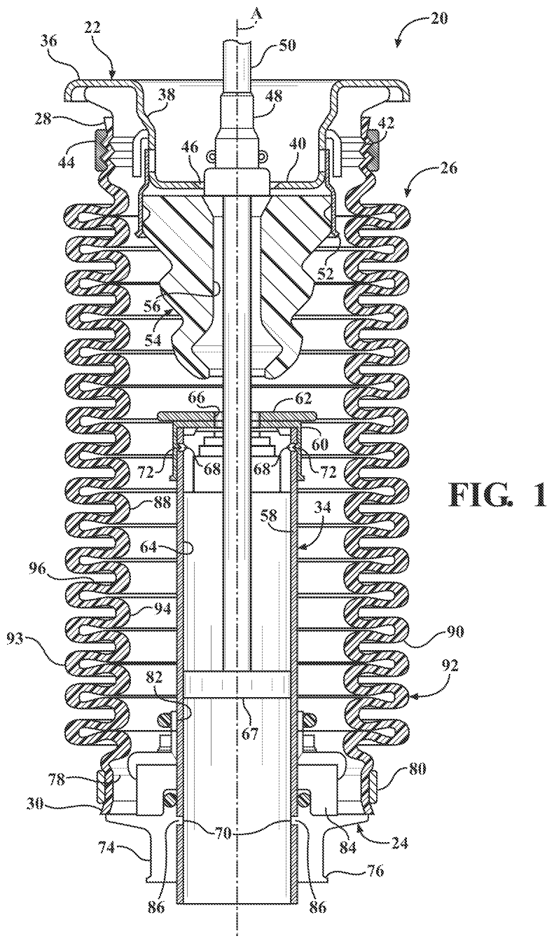

Referring to the Figures, wherein like numerals indicate corresponding parts throughout the several views, an air suspension assembly 20 constructed according to an embodiment of the present invention is generally shown in FIGS. 1-4.

The air suspension assembly 20, as generally shown in FIGS. 1-3, may be used to support and stabilize vehicles such as cars, vans, trucks, motorbikes, bicycles but also may be used on heavy-duty vehicles, such as semi-trucks, trailers, or the like. The air suspension assembly 20 includes a top 22 and a bottom 24 disposed on a center axis A and spaced apart from one another. According to an embodiment of the present invention, the top 22 may have a cylindrical shape and a U-shaped cross-section. The bottom 24 may have an inverted cup shape and an inverted U-shape cross-section. A bellows 26, such as an air sleeve, made from an elastomeric material (e.g. a versatile thermoplastic elastomer) having a tubular shape is disposed on the center axis A and extends annularly about the center axis A between a first end 28 and a second end 30. According to an embodiment of the present invention, the bellows 26 may be thermalplastic elastomer that is a heat resilient and/or chemical resistant material, such as the thermal plastic elastomer sold under the trademark Hytrel by DuPont. According to an embodiment of the present invention, the bellows 26 may consist essentially of the thermalplastic elastomer. According to another embodiment of present invention, the bellows 26 may consist of the thermalplastic elastomer. The first end 28 of the bellows 26 is secured to the top 22 and the second end 30 of the bellows 26 is secured to the bottom 24 defining a chamber 32 extending between the top 22, the bottom 24, and the bellows 26. In other words, the bellows 26 connects the top 22 to the bottom 24 to establish the chamber 32 between the top 22, the bellows 26, and the bottom 24. A damper 34 having a generally cylindrical shape is disposed on the center axis A at least partially within the chamber 32 and is secured to the bottom 24.

The top 22 includes a plate 36, which may have a circular shape, disposed on the center axis A for securing the air suspension assembly 20 to the vehicle. A side wall 38 having a cylindrical shape extends perpendicularly outwardly from the plate 36, parallel to the center axis A, and radially inwardly towards the chamber 32. A base wall 40 extends radially inwardly from the side wall 38 toward the center axis A. The side wall 38 includes a plurality of first ridges 42, spaced from one another, extending outwardly from the side wall 38 and annularly about the side wall 38 in a perpendicular relationship with the center axis A to receive the first end 28 of the bellows 26. A first ring 44 having a circular shape is disposed on the bellows 26 at the first end 28 of the bellows 26 and extends annularly about the side wall 38 of the top 22 to secure the bellows 26 to the side wall 38 of the top 22. In other words, the first ring 44 sandwiches the first end 28 of the bellows 26 between the first ring 44 and the first ridges 42 of the side wall 38.

The base wall 40 defines a hole 46 having a circular shape and disposed on the center axis A. A piston rod guide 48 having a cylindrical shape extends annularly about the center axis A and through the hole 46. The piston rod guide 48 may form a first central channel (not shown) extending along the center axis A for receiving a piston rod 50. A sleeve 52 is secured to the side wall 38 and extends annularly along the center axis A into the chamber 32. An internal spring 54 of an elastomeric material (e.g. a versatile thermoplastic elastomer), having a generally frustroconical shape, extends along the center axis A and is connected to and extends from the sleeve 52 of the top 22 into the chamber 32. According to an embodiment of the present invention, the internal spring 54 can be made from a heat resilient and/or chemical resistant material, such as a thermalplastic elastomer sold under the trademark Hytrel by DuPont. In some embodiments, the material (for example, Hytrel by DuPont) and dimensions of the bellows 26 may allow the bellows to be formed by blow-molding, as opposed to typical complex and costly rubber-forming techniques. The internal spring 54 defines a second central channel 56, having a generally cylindrical shape, disposed in-line with the first central channel and extending along the center axis A along the length of the internal spring 54 for allowing the piston rod 50 to extend into the chamber 32. In some embodiments, the internal spring 54 is a jounce bumper and may be made of a compressible material to absorb the energy of the damper 34 when the air suspension assembly 20 is compressed.

The damper 34 includes a housing 58 and a cap 60, each having a cylindrical shape and extending along the center axis A. The housing 58 extends between a proximal end (not shown) and a distal end 62. The distal end 62 is located in the chamber 32. The proximal end is located outside of the chamber 32 for connecting the air suspension assembly 20 to the vehicle. The cap 60 is secured to the housing 58 at the distal end 62 to form a compartment 64 inside the housing 58. The cap 60 and the housing 58 define a third central channel 66 extending along the center axis A for receiving the piston rod 50. It should be appreciated that, in some embodiments, the damper 34 may be a hydraulic damper with hydraulic fluid disposed inside the compartment 64, and the piston rod 50 may include a hydraulic piston 67 disposed inside the compartment 64 for interacting with the hydraulic fluid. The piston rod 50 and the hydraulic piston 67 are movable between a compression stroke and a rebound stroke. During the compression stroke, the piston rod 50 and the hydraulic piston 67 move axially away from the cap 60. During the rebound stroke, the piston rod 50 and the hydraulic piston 67 move axially toward the cap 60.

The housing 58 further defines two sets of bores 68, 70, including a first set of bores 68 and a second set of bores 70, axially spaced apart from one another. The first set of bores 68 is located adjacent the distal end 62 of the housing 58 and disposed about the center axis A. Each bore 68 of the first set of bores 68 is circumferentially spaced apart from adjacent bores of the first set of bores 68 for interacting with the cap 60. The cap 60 includes a plurality of protrusions 72 extending radially inwardly, wherein a protrusion 72 of the plurality of protrusions 72 is received in a bore of the first set of bores 68 to secure the cap 60 to the housing 58. The second set of bores 70 is located outside of the chamber 32 adjacent the bottom 24. The second set of bores 70 are spaced circumferentially from one another about the center axis A for interacting with the bottom 24.

The bottom 24 includes a body 74 extending annularly about the center axis A between the damper 34 and the bellows 26. The body 74 has a periphery 76 extending about the body 74. The body 74 includes a plurality of second ridges 78, axially spaced apart from one another, extending outwardly from the body 74 perpendicular to the center axis A for receiving the second end 30 of the bellows 26. A second ring 80 having a circular shape is disposed on the bellows 26 at the second end 30 of the bellows 26 and extending annularly about the body 74 of the bottom 24 to secure the bellows 26 to the body 74 of the bottom 24. In other words, the second end 30 of the bellows 26 is sandwiched between the second ring 80 and the second ridges 78 to secure the second end 30 of the bellows 26 to the bottom 24. The bottom 24 defines a fourth central channel 82 having a cylindrical shape disposed on the center axis A for receiving the damper 34. The bottom 24 further includes a collar portion 84 having a cylindrical shape extending along the center axis A for securing the bottom 24 to the damper 34. According to an embodiment of the present invention, the collar portion 84 may include at least one pin 86 extending radially inwardly toward the center axis A for engaging the second set of bores 70 of the housing 58 to secure the damper 34 to the bottom 24. It should be noted that the damper 34 can be secured to the bottom 24 using other ways, such as clamps, screws, or other well-known methods.

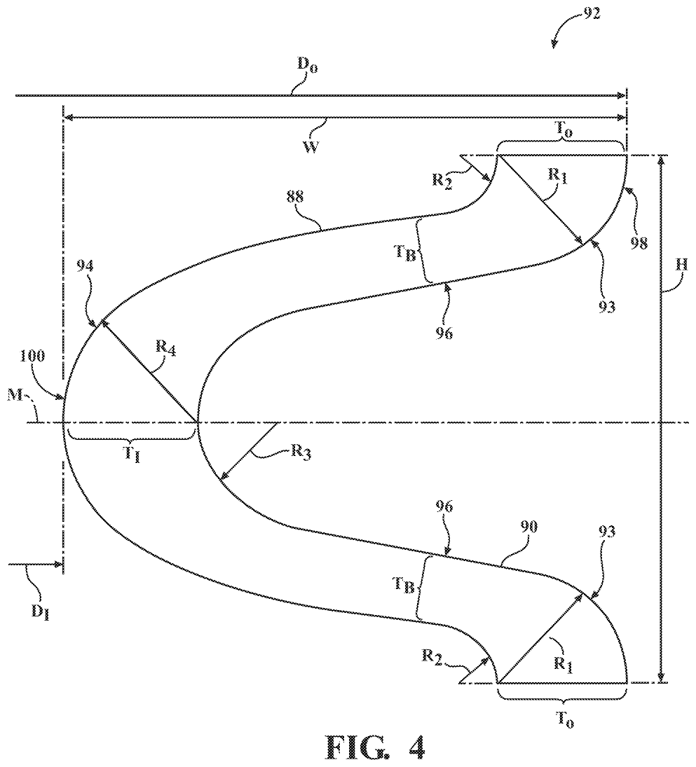

According to an embodiment of the present invention, the bellows 26 may have a varying bellows thickness T formed between an interior surface 88 disposed adjacent the chamber 32 and an exterior surface 90 disposed outside of the chamber 32. The bellows 26 has a series of convolutes 92, each having a generally sinusoidal-shaped (e.g., “W”-shaped) cross-section, extending between the first end 28 and the second end 30 to provide strength to the bellows 26 and to allow the bellows 26 to compress and retract. Referring now to FIG. 4, a convolute 92 of the series of convolutes 92 extends in a wave-like fashion between two outer lobes 93, each having a generally arcuate-shaped cross-section, with an inner lobe 94 disposed between the outer lobes 93. The outer lobes 93, spaced apart from one another along the center axis A, are disposed radially outwardly from the inner lobe 94. Each outer lobe 93 delimits an outer diameter D_{O} of the bellows 26. A bridge portion 96, having a generally constant bridge portion thickness T_{B} extending between the interior surface 88 and the exterior surface 90, extends between each outer lobe 93 and the inner lobe 94 to connect the inner lobe 94 to the outer lobe 93. The inner lobe 94, having a generally U-shaped cross-section, is disposed radially inwardly from the outer lobes 94 and between the outer lobes 94. The inner lobe 94 extends between the bridge portions 96 and delimits an inner diameter D_{I} of the bellows 26.

The outer lobe 93 has an exterior outer lobe radius R₁ and an interior outer lobe radius R₂, thereby defining an outer lobe thickness To extending between the exterior surface 90 and the interior surface 88. The inner lobe 94 has an exterior inner lobe radius R₃ and an interior inner lobe radius R₄, thereby defining an inner lobe thickness T_{I} extending between the interior surface 88 and the exterior surface 90. As illustrated, the outer lobe thickness T_{O} may vary along the profile of the outer lobe 93 with the outer lobe thickness T_{O} being the greatest at an outer tip 98 of the outer lobe 93. The inner lobe 94 thickness may also vary along the profile of the inner lobe 94 with the inner lobe thickness T_{I} being the greatest at an inner tip 100 of the inner lobe 94. The bridge portion 96 has a bridge portion thickness T_{B} extending between the interior surface 88 and the exterior surface 90. Each convolute 92 has a height H extending between the outer lobes 93 and a width W extending between the outer diameter D_{O} and the inner diameter D_{I}. The inner lobe 94 is disposed along a mid-plane M of the convolute 92, which may be roughly half of the height H. It should be appreciated that the bridge portion 96 may have a slight radius of curvature (i.e., a bridge portion exterior radius and a bridge portion interior radius) between the outer lobe 93 and the inner lobe 94, or may be have a generally linear profile. According to an embodiment of the present invention, the bellows 26 may include about 16 convolutes extending between the first end 28 and the second end 30 of the bellows 26. It should be appreciated that, in some embodiments of the present invention, the bellows 26 may be molded to or fastened to a hardened sleeve portion disposed amid the convolutes 92 or between the plurality of convolutes 92 and the top 22 or the bottom 24 to provide additional structural integrity to the bellows 26.

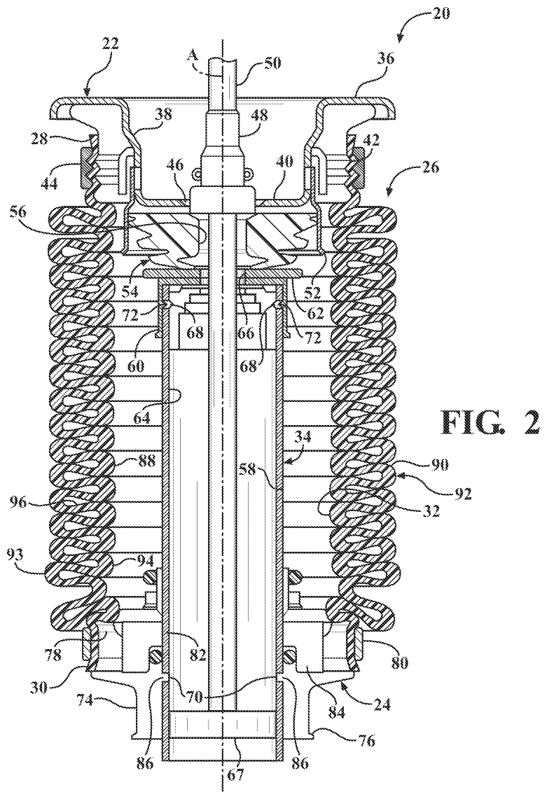

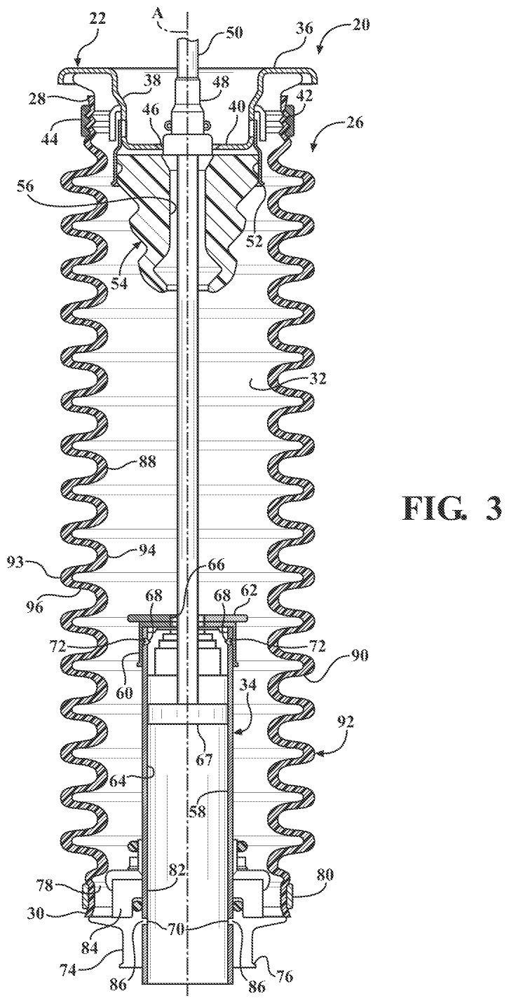

In operation, the bottom 24, the damper 34, and the bellows 26 are moveable along the center axis A between an undeformed position, as illustrated in FIG. 3, and a compressed position (i.e. full bump position), as illustrated in FIG. 2. In the compressed position, the internal spring 54 is compressed between the base wall 40 and the damper 34. Accordingly, in the compressed position the bellows 26 are also compressed wherein adjacent inner lobes 94 are abutting one another. In addition, the compressed position, adjacent outer lobes 93 are abutting one another. In the undeformed position, the internal spring 54 and the bellows 26 are undeformed. It should be noted that during operation, the air suspension assembly 20 may also be maintained in a default operating position with the air suspension assembly 20 being partially compressed, as illustrated in FIG. 1. When the air suspension assembly 20 compresses due to, for example, the vehicle passing over a bump, the bottom 24, the damper 34, and the bellows 26 are moved axially towards the top 22 thereby compressing the air suspension assembly 20. During more intense compression, the cap 60 of the damper 34 engages and compresses the internal spring 54 to soften the contact between the damper 34 and the top 22.

The dimensions of the convolute 92 in the undeformed position, as illustrated in FIG. 4, may allow the load to deflect in a predictable way compared to traditional air springs. In other words, the convolute 92 shape may offer load compensation and a raising/lowering function of a vehicle similar to the load compensation of traditional air springs. For example, in the undeformed position, the outer diameter D_{O} of the bellows 26, as defined at the exterior surface 90 of the outer lobe 93, may be about 71.44 millimeters, and the inner diameter D_{I} of the bellows, as defined at the interior surface 88 of the inner lobe 94, may be about 45.1 millimeters. The height H of the convolute 92 may be about 24.68 millimeters, the distance from the outer lobe 93 to the mid-plane M may be about 12.34 millimeters, and the width W may be about 26.31 millimeters. Furthermore, the exterior outer lobe radius R₁ may be 5.21 millimeters, and the interior outer lobe radius R₂ may be about 2.74 millimeters.

In the undeformed position, the interior inner lobe radius R₃ may be about 4.22 millimeters and extend about 30 degrees on one side of the mid-plane M and 30 degrees on the other side of the mid-plane M. In other words, interior inner lobe radius R₃ may extend 2.13 mm on either side of the mid-plane M. The outer lobe thickness T_{O} may vary across the profile of the outer lobe 93, but may be about at least about 6.13 millimeters. The inner lobe thickness T_{I} may also vary across the profile of the inner lobe 94, but may be at least about 6.25 millimeters. The exterior surface 88 of the bridge portion 96 may extend at an angle of about 11 degrees relative to outer lobe 93 and the interior surface 90 of the bridge portion 96 may extend at an angle of about 8 degrees relative to the outer lobe 94. In other words, the bridge portion thickness T_{B} may vary across the profile of the bridge portion 96. For example, the bridge portion thickness T_{B} may increase between the outer lobe 93 and the inner lobe 94.

According to an embodiment of the present invention, a valve (not shown) may be disposed in fluid communication with the chamber for changing pressure in the chamber 32 (i.e., controlling pressurized air contained in the chamber 32) in response to a force applied to the air suspension assembly 20. By controlling a pressure of the pressurized air to the chamber 32 based on the force applied to the air suspension assembly 20, the bellows 26 may be stiffened and the thrust of the air spring may be adjusted. In some embodiments, the pressurized air in the chamber corresponds to a position of the bottom 24 relative to the top 22. For example, the valve may be configured to selectively apply between 0 and at least about 5 bars of air pressure to the chamber 32 to control the full range of the air suspension assembly 20. The strength of the bellows 26 due to the convolute 92 design may allow for the air suspension assembly 20 to function and be controlled with a lower-powered compressor. For example, the thickness, height, width, curvature, and number of convolutes 92 may provide resiliency to the air suspension assembly 20.

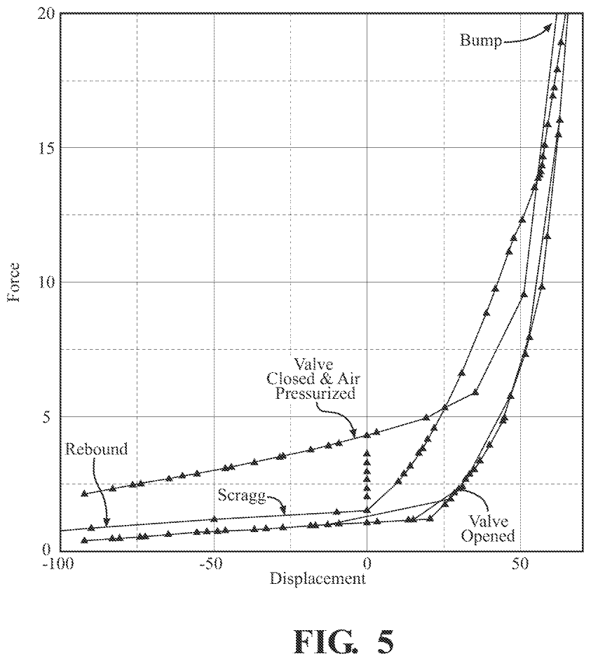

With reference to FIG. 5, it should be appreciated that in some embodiments, the load deflection curve of the air suspension assembly 20 may generally correlate to the load deflection curves of traditional air springs with selective control of the valve. For example, as shown in FIG. 5, as the bellows 26 returns from receiving about 1530 Newtons under scragg, the valve is opened as the rate of force on the bellows falls to around 18 Newtons per millimeter. To achieve traditional spring responses, as a second compression is applied to the air suspension assembly 20, the valve is closed and may hold a pressure of about 3 bars in the chamber 32 during the second compression. In some embodiments, in the default operating position, the air suspension assembly 20 is exposed to about 1090 Newtons when the valve is opened and about 1530 Newtons under scragg. The valve may be closed to hold the air pressure of the chamber 32 at about 3 bars in the default position when air suspension assembly 20 supports a load of about 4320 Newtons. During a full compression (i.e., full bump), the air suspension assembly 20 may experience between 20 and 25 kilo-Newtons per millimeter.

Obviously, many modifications and variations of the present invention (for example as a standalone air spring assembly compare to the assembly described previously as being built around a damper) are possible in light of the above teachings and may be practiced otherwise than as specifically described while within the scope of the appended claims. The use of the word “said” in the apparatus claims refers to an antecedent that is a positive recitation meant to be included in the coverage of the claims whereas the word “the” precedes a word not meant to be included in the coverage of the claims.

What is claimed is:

1. An air suspension assembly comprising:
a top and a bottom disposed on a center axis and spaced apart from one another;
a bellows of an elastomeric material extending between a first end secured to said top and a second end secured to said bottom defining a chamber extending between said top, said bottom, and said bellows for containing pressurized air, whereby a pressure of said pressurized air is controlled based on a force applied;
said bellows having an interior surface and an exterior surface and including a plurality of convolutes extending between said first end and said second end; and
each convolute of said plurality of convolutes including a pair of outer lobes and an inner lobe with each outer lobe of said pair of outer lobes having an outer lobe thickness extending between said interior surface and said exterior surface of said bellows.

2. The air suspension assembly as set forth in claim 1, wherein said inner lobe is disposed radially inwardly from said outer lobes and between said outer lobes, with said inner lobe having an inner lobe thickness extending between said interior surface and said exterior surface of said bellows, wherein said outer lobe thickness and said inner lobe thickness are approximately equivalent.

3. The air suspension assembly as set forth in claim 2 further including a bridge portion extending between said inner lobe and each outer lobe of said pair of outer lobes, with said bridge portion having a bridge portion thickness extending between said interior surface and said exterior surface of said bellows; and
wherein each of said outer lobe thickness and said inner lobe thickness is greater than said bridge portion thickness.

4. The air suspension assembly as set forth in claim 3, wherein said outer lobe thickness varies along said outer lobe with said outer lobe thickness being the greatest at an outer tip of said outer lobe.

5. The air suspension assembly as set forth in claim 3, wherein said inner lobe thickness varies along said inner lobe with said inner lobe thickness being the greatest at an inner tip of said inner lobe.

6. The air suspension assembly as set forth in claim 3, wherein said bridge portion thickness is generally constant along said bridge portion.

7. The air suspension assembly as set forth in claim 1, wherein a pressure of said pressurized air in said chamber corresponds to a position of said bottom relative to said top.

8. The air suspension assembly as set forth in claim 1 further including a damper connected to said bottom and moveable with said bellows between a compressed position and an undeformed position of the air suspension assembly; and
a jounce bumper connected to said top for absorbing energy of said damper when said air suspension assembly is compressed, with said damper compressing said jounce bumper in said compressed position and said damper spaced from said jounce bumper in said undeformed position.

9. An air suspension assembly comprising:
a top and a bottom disposed on a center axis and spaced apart from one another;
a piston disposed on said center axis spaced from said top;
a bellows extending about said center axis between a first end secured to said top and a second end secured to said bottom connecting said top and said bottom defining a chamber extending between said top, said bottom, and said bellows;
said bellows having an interior surface and an exterior surface and including a plurality of convolutes extending between said first end and said second end;
said chamber containing pressurized air in fluid communication with said piston, with said pressurized air controlled based on a force applied to said air suspension assembly;
a damper connected to said piston and moveable between a compressed position and an undeformed position of the air suspension assembly; and
a jounce bumper connected to said top for absorbing energy of said damper when said air suspension assembly is compressed, with said damper compressing said jounce bumper in said compressed position and said damper spaced from said jounce bumper in said undeformed position.

10. The air suspension assembly as set forth in claim 9, wherein each of said plurality of convolutes extends between a pair of outer lobes spaced from one another along said center axis, with said outer lobe having an outer lobe thickness extending between said interior surface and said exterior surface of said bellows; and
an inner lobe is disposed radially inwardly from said outer lobes and between said outer lobes, with said inner lobe having an inner lobe thickness extending between said interior surface and said exterior surface of said bellows, wherein said outer lobe thickness and said inner lobe thickness are approximately equivalent.

11. The air suspension assembly as set forth in claim 10 further including a bridge portion extending between said inner lobe and each one of said pair of outer lobes, with said bridge portion having a bridge portion thickness extending between said interior surface and said exterior surface of said bellows; and
wherein each of said outer lobe thickness and said inner lobe thickness is greater than said bridge portion thickness.

12. The air suspension assembly as set forth in claim 11, wherein said outer lobe thickness varies along said outer lobe, with said outer lobe thickness being greatest at an outer tip of said outer lobe.

13. The air suspension assembly as set forth in claim 11, wherein said inner lobe thickness varies along said inner lobe, with said inner lobe thickness being greatest at an inner tip of said inner lobe.

14. The air suspension assembly as set forth in claim 11, wherein said bridge portion thickness is generally constant along said bridge portion.

15. The air suspension assembly as set forth in claim 9, wherein a pressure of said pressurized air in said chamber corresponds to a position of said bottom relative to said top.

16. A bellows for an air suspension assembly, said bellows comprising:
an interior surface and an exterior surface;
a first end secured to a top of said air suspension assembly and a second end secured to a bottom of said air suspension assembly connecting said top and said bottom defining a chamber extending about a center axis between said top, said bottom, and said bellows;
a plurality of convolutes extending between said first end and said second end;
each of said plurality of convolutes extending between a pair of outer lobes spaced from one another along said center axis, with said outer lobe having an outer lobe thickness extending between said interior surface and said exterior surface of said bellows;
an inner lobe disposed radially inwardly from said outer lobes and between said outer lobes, with said inner lobe having an inner lobe thickness extending between said interior surface and said exterior surface of said bellows, wherein said outer lobe thickness and said inner lobe thickness are approximately equivalent; and
a bridge portion extending between said inner lobe and each one of said pair of outer lobes, with said bridge portion having a bridge portion thickness extending between said interior surface and said exterior surface of said bellows;
wherein each of said outer lobe thickness and said inner lobe thickness is greater than said bridge portion thickness.

17. The bellows as set forth in claim 16, wherein said outer lobe thickness varies along said outer lobe, with said outer lobe thickness being greatest at an outer tip of said outer lobe; and
wherein said inner lobe thickness varies along said inner lobe, with said inner lobe thickness being greatest at an inner tip of said inner lobe.

18. The bellows as set forth in claim 16, wherein said bridge portion thickness is generally constant along said bridge portion.
